(19) United States
(12) Patent Application Publication
(10) Pub. No.: US 2003/0043168 A1
(43) Pub. Date: Mar. 6, 2003

(54) Liquid crystal display device having inversion flicker compensation

(75) Inventor: Sandeep M. Dalal, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/947,814

(22) Filed: Sep. 6, 2001

(51) Int. Cl. G09G 5/02

(52) U.S. Cl. 345/601

(57) ABSTRACT

A display driver for implementing an inversion flicker compensation method is disclosed. The inversion flicker compensation method is applicable to a liquid crystal display device that is operable to emit a luminous output in response to a reception of a voltage drive signal and a voltage reference signal. The display driver is operated in accordance with the method to provide the voltage drive signal to the liquid crystal display device in response to a reception of a voltage data signal having a data voltage level indicative of a gray level of a color component. The display driver includes a gamma lookup table for the voltage drive signal that lists a pair of drive voltage levels for the voltage drive signal that correspond to the gray level as indicated by the data voltage level of the voltage data signal. The drive voltage levels have opposing polarities relative to a reference voltage level of the voltage reference signal.

### BACKGROUND OF THE INVENTION

1. Field of the Invention

The present invention generally relates to video display devices. The present invention specifically relates to a construction of gamma lookup tables for providing inversion flicker compensation to a liquid crystal display device.

2. Description of the Related Art

FIG. 1 illustrates a conventional LCD device 13 for transmitting a luminous output 14 in response to voltage drive signals V_{AS4-AS6} in analog form. FIG. 2 illustrates an exemplary luminance transmission percentage of luminous output 14 in terms of a red color component, a green color component, and a blue color component as a function of various levels of voltage drive signals V_{AS4-AS6}. As known in the art, each drive voltage signal V_{AS4-AS6} is applied to each column (not shown) of corresponding LCD panels (not shown) of LCD device 13. Each column is connected via a transistor (not shown) to each pixel (not shown) in each row (not shown) of each LCD panel. LCD device 13 also includes a top plate (not shown) known as a counter electrode for each LCD panel. Each counter electrode receives a voltage reference signal V_{REF} in analog form.

For the liquid crystal material within each pixel of each LCD panel to operate properly, the level of drive voltage signals V_{AS4-AS6} are modulated relative to voltage reference signal V_{REF}. For example, if voltage reference signal V_{REF} has a level of six (6) volts, then the levels of voltage drive signals V_{AS4-AS6} traverse a range from zero (0) volts to twelve (12) volts as shown in FIG. 2. A low inversion polarity range for voltage drive signals V_{AS4-AS6} is between zero (0) volts and six (6) volts. A high inversion polarity range for voltage drive signals V_{AS4-AS6} is between six (6) volts and twelve (12) volts. Frame inversion implies the levels of voltage drive signals V_{AS4-AS6} are within the low inversion polarity range for one video frame, the levels of voltage drive signals V_{AS4-AS6} are within the high inversion polarity range for a successive video frame, and so on, and so on.

Gamma circuit 10 includes conventional gamma lookup tables (not shown) for facilitating a reception of voltage drive signals V_{AS4-AS6} by LCD device 13 whereby, as shown in FIG. 3, LCD device 13 transmits luminous output 14 at a desired luminance response as related to voltage data signal V_{DS1-DS3} in digital form. Voltage data signal V_{DS1-DS3} are indicative of a particular gray level input from a conventional video source (not shown) as related to the red color component, the green color component, and the blue color component, respectively. For example, voltage data signal V_{DS1-DS3} can consist of eight bits representing 256 gray levels over a range of 00000000 (normalized as 0 in FIG. 3) to 11111111 (normalized as 1 in FIG. 3).

In response to a reception of voltage data signal V_{DS1-DS3}, gamma circuit 10 obtains levels for voltage drive signals V_{AS4-AS6} for the low inversion polarity range that corresponds to the levels of voltage data signal V_{DS1-DS3}, respectively. A digital-to-analog converter (DAC) 11 transform voltage data signal V_{DS1-DS3} to voltage drive signals V_{AS1-AS3}, respectively, in analog form that is only provided with levels within the low inversion polarity range based on an average luminance response of luminous output 14 in both inversion polarity ranges. Thus, to achieve frame inversion, a voltage inversion circuit 12 provides voltage drive signals V_{AS4-AS6} in response to voltage drive signals V_{AS1-AS3}, respectively, with the levels of voltage drive signals V_{AS4-AS6} being within the low inversion polarity range (e.g., equating control voltage V_{AS1}) for one video frame, the levels of voltage drive signals V_{AS4-AS6} being within the high inversion polarity range (e.g., (2*V_{REF})-V_{AS1}) for a successive video frame, and so on, and so on.

Luminous output 14 experiences an inversion flicker whenever one or more voltage drive signals V_{AS4-AS6} are attenuated prior to being applied to the appropriate pixels with LCD device 13. As known in the art, such attenuation typically occurs within conventional LCD device 13 whenever levels of voltage drive signals V_{AS4-AS6} are within the high inversion polarity range. Consequently, as exemplary illustrated in FIG. 4, a time-based amplitude measurement of luminous output 14 as related to each gray level input indicated by the levels of the voltage data signals V_{DS1-DS3} would exhibit uneven peaks relative to an average luminous response of luminous output 14 with the uneven peaks being representative of the inversion flicker.

Clearly, a disadvantage of employing gamma circuit 10, DAC 11, and voltage inversion circuit 12 to drive LCD device 13 is the failure to compensate for any occurrence of an inversion flicker of luminous output 14. Therefore, there is a need to provide a method and a device for eliminating inversion flicker within LCD device 13. The present invention addresses this need.

### SUMMARY OF THE INVENTION

The present invention relates to a method and a device for eliminating inversion flicker within a LCD device. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

A first form of the present invention is a device comprising a LCD device operable to emit a luminous output in response to a reception of a voltage drive signal and a voltage reference signal. The device further comprises a display driver operable to provide the voltage drive signal to the LCD device in response to a reception of a voltage data signal having a data voltage level indicative of a gray level. The display driver includes a gamma lookup table for the voltage drive signal with the gamma lookup table listing a pair of drive voltage levels for the voltage drive signal that correspond to the gray level as indicated by a data voltage level of the voltage data signal. The drive voltage levels for the voltage drive signal have opposing polarities relative to a reference voltage level of the voltage reference signal.

A second form of the present invention is a method for applying an inversion flicker compensation to a luminous output being emitted by a liquid crystal display device in response to a reception of a voltage drive signal and a voltage reference signal. First, a display driver is operated to receive a voltage data signal having a data voltage level indicative of a first gray level. Second, the display driver is operated to obtain a pair of drive voltage levels for the voltage drive signal in response to the reception of the voltage data signal having the data voltage level. The pair of drive voltage levels having opposing polarities relative to a reference voltage level of the voltage reference signal. Finally, the display driver is operated to provide the voltage drive signal to the liquid crystal display device in a frame inversion manner involving the pair of drive voltage levels during a duration of the data voltage level indicating the first gray level.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 is a block diagram of a conventional display driver employed to drive a liquid crystal display (LCD) device;

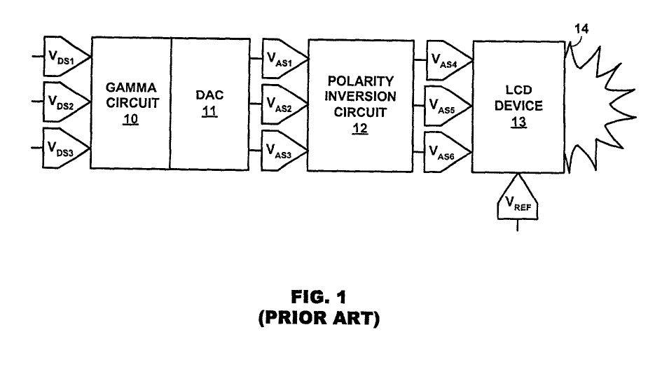

FIG. 2 is a graph exemplary illustrating a luminous response curve of the FIG. 1 liquid crystal display in terms of a red color component, a green color component, and a blue color component as a function of the levels of corresponding voltage drive signals;

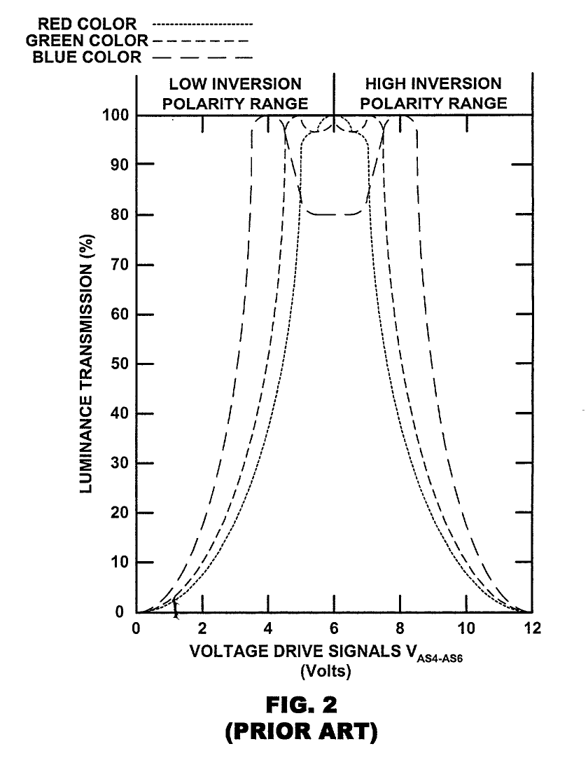

FIG. 3 is a graph exemplary illustrating a desired luminous response curve of a luminous output from the FIG. 1 LCD device as related to a voltage data signal;

FIG. 4 illustrates an exemplary time-based luminance amplitude measurement of the luminance output of the FIG. 1 LCD device as related to a gray level input indicated by a voltage data signal;

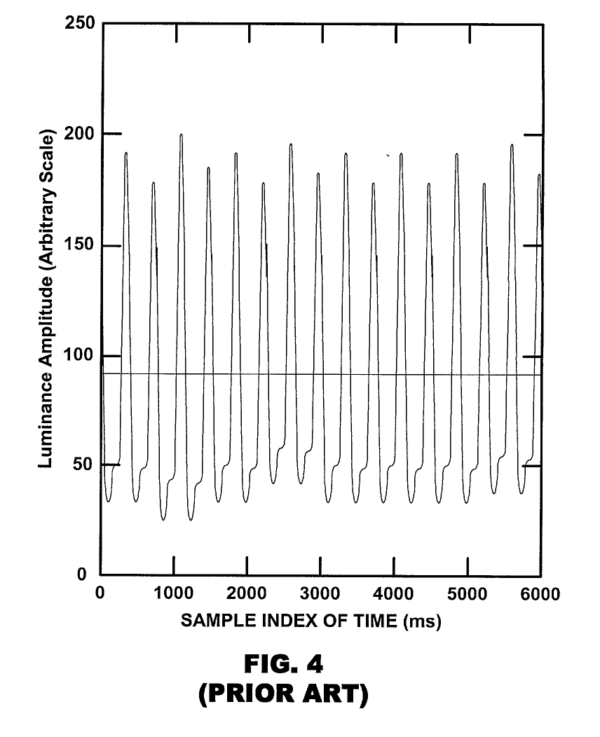

FIG. 5 is a block diagram of a display driver in accordance with the present invention that is employed to drive the FIG. 1 LCD device;

FIG. 6A is an exemplary red color gamma lookup table in accordance with the present invention relating data voltage levels of a voltage data signal from a video source to drive voltage levels of a voltage drive signal to the FIG. 1 LCD device;

FIG. 6B is an exemplary green color gamma lookup table in accordance with the present invention relating data voltage levels of a voltage data signal from a video source to drive voltage levels of a voltage drive signal to the FIG. 1 LCD device;

FIG. 6C is an exemplary blue color gamma lookup table in accordance with the present invention relating data voltage levels of a voltage data signal from a video source to drive voltage levels of a voltage drive signal to the FIG. 1 LCD device;

FIG. 7A illustrates a system in accordance with the present invention for generating the FIGS. 6A-6C gamma lookup tables;

FIG. 7B illustrates a flowchart of a method in accordance with the present invention for generating the FIGS. 6A-6C gamma lookup tables;

FIG. 8A is an exemplary red color gamma lookup table in accordance with the present invention relating to a black voltage input level and a white voltage input level of a voltage data signal to corresponding drive voltage levels of a voltage drive signal;

FIG. 8B is an exemplary green color gamma lookup table in accordance with the present invention relating to a black voltage input level and a white voltage input level of a voltage data signal to corresponding drive voltage levels of a voltage drive signal;

FIG. 8C is an exemplary blue color gamma lookup table in accordance with the present invention relating to a black voltage input level and a white voltage input level of a voltage data signal to corresponding drive voltage levels of a voltage drive signal; and

FIG. 9 is illustrates an exemplary time-based luminance amplitude measurement of a luminance output of a FIG. 7 projector as related to a gray level input indicated by a voltage data signal.

### DETAILED DESCRIPTION OF THE PRESENTLY PREFERRED EMBODIMENTS

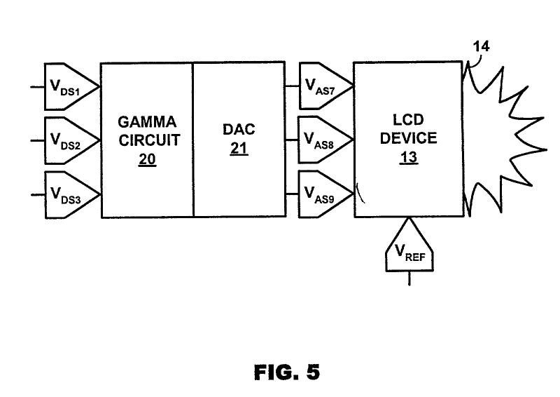

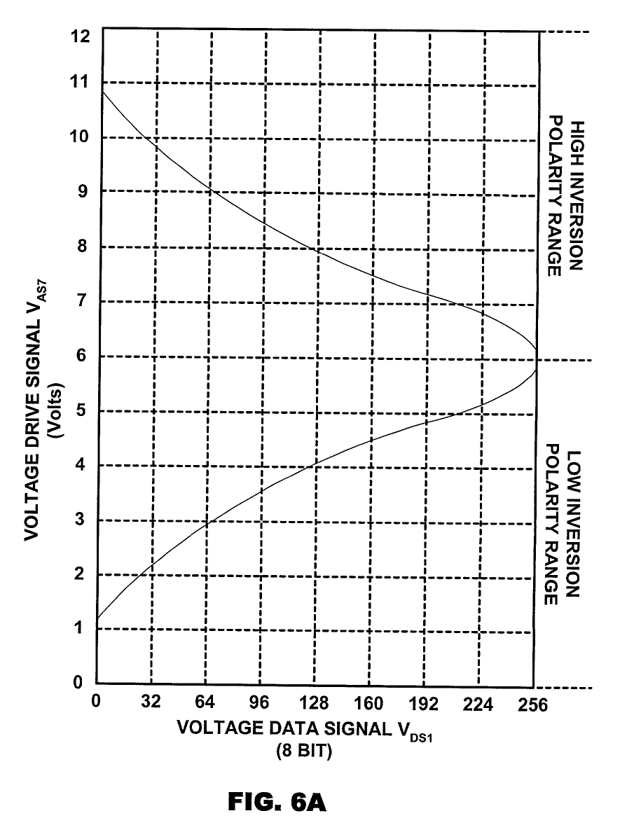

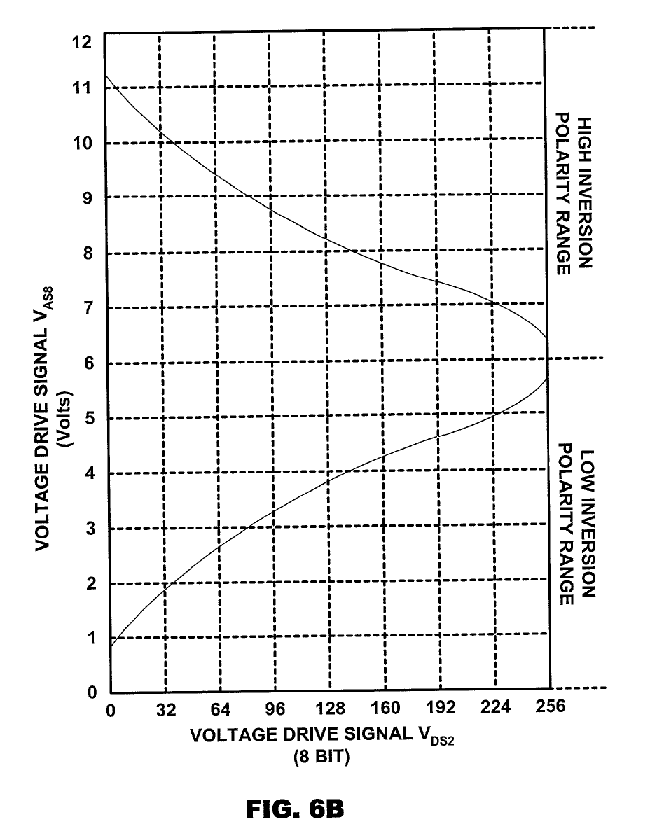

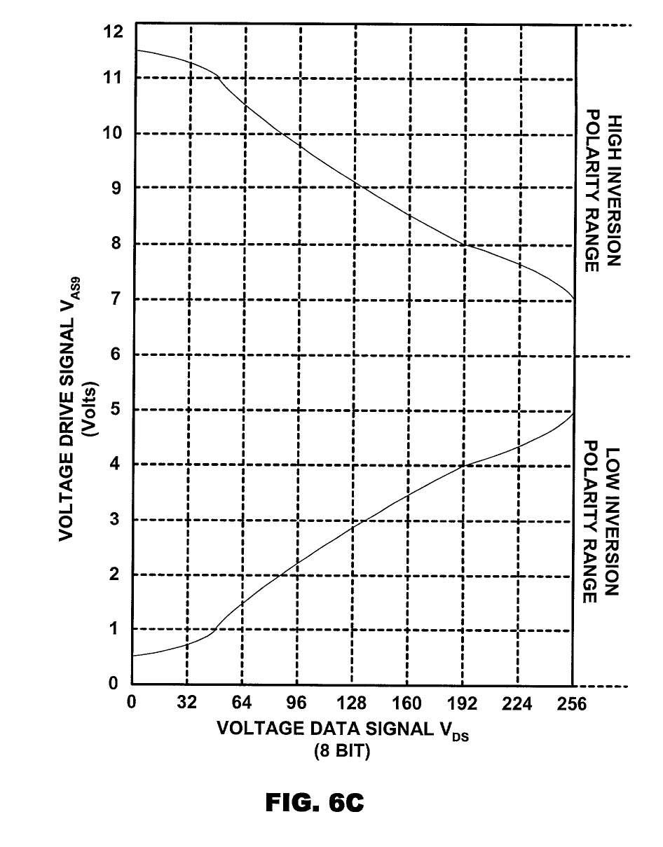

FIG. 5 illustrates a display driver of the present invention comprising a gamma circuit 20 and a digital-to-analog converter (DAC) 21. Gamma circuit 20 includes gamma lookup tables for a red color component, a green color component, and a blue color component in accordance with the principles of the present invention. FIG. 6A illustrates an exemplary illustration of a red color gamma lookup table listing a pair of drive voltage levels of a drive voltage signal V_{AS7} having opposing polarities relative to a reference voltage level (6 volts) of reference voltage signal V_{REF} for each graylevel input indicated by a data voltage level of voltage data signal V_{DS1}. FIG. 6B illustrates an exemplary illustration of a green color gamma lookup table listing a pair of drive voltage levels of a drive voltage signal V_{AS8} having opposing polarities relative to a reference voltage level (6 volts) of reference voltage signal V_{REF} for each graylevel input indicated by a data voltage level of voltage data signal V_{DS2}. FIG. 6C illustrates an exemplary illustration of a blue color gamma lookup table listing a pair of drive voltage levels of a drive voltage signal V_{AS9} having opposing polarities relative to a reference voltage level (6 volts) of reference voltage signal V_{REF} for each graylevel input indicated by a data voltage level of voltage data signal V_{DS3}.

The gamma lookup tables of FIGS. 6A-6C reflect an inversion flicker compensation for luminous output 14 as emitted by LCD device 13. Specifically, gamma circuit 20 obtains the appropriate pairs of drive voltage levels for voltage drive signals V_{AS7-AS9} as related to the data voltage levels of voltage drive signals V_{DS1-DS2}, respectively. For example, as shown in FIG. 6A, gamma circuit 20 would obtain drive voltage levels of approximately four (4) volts and eight (8) volts when the data voltage level of voltage data signal V_{DS1} indicates a gray level of 127.

DAC 21 transforms voltage data signals V_{DS1-DS3} into voltage drive signals V_{AS7-AS9}, respectively, in accordance with the appropriate pairs of drive voltage levels obtained from the gamma lookup tables, and provides voltage drive signals V_{AS7-AS9} to LCD device 13 in a frame inversion manner. For example, DAC 21 would transform voltage data signal V_{DS1} having a data voltage level indicating a gray level of 127 for the red color component into voltage drive signal V_{AS7} having a drive voltage level of approximately four (4) volts for one video frame, a drive voltage level of approximately eight (8) volts for a successive video frame, and so on, and so on. This frame inversion would continue until the data voltage level of voltage data signal V_{DS1} was increased or decreased to indicate a different gray level of the red color component.

In response to a reception of voltage drive signals V_{AS7-AS9}, LCD device 13 emits luminous output 14 without luminous output 14 experiencing any inversion flicker. The inversion flicker compensation is maintained as the data voltage level(s) of one or more of voltage data signals V_{DS1-DS3} are increased or decreased to indicated a different gray level of the corresponding color component.

More or less gamma lookup tables as well as gamma lookup tables for other color components may be utilized in other embodiments of a display drive in accordance with the present invention.

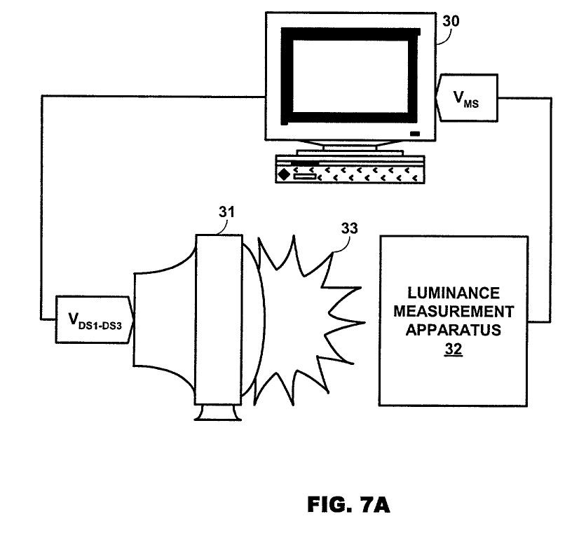

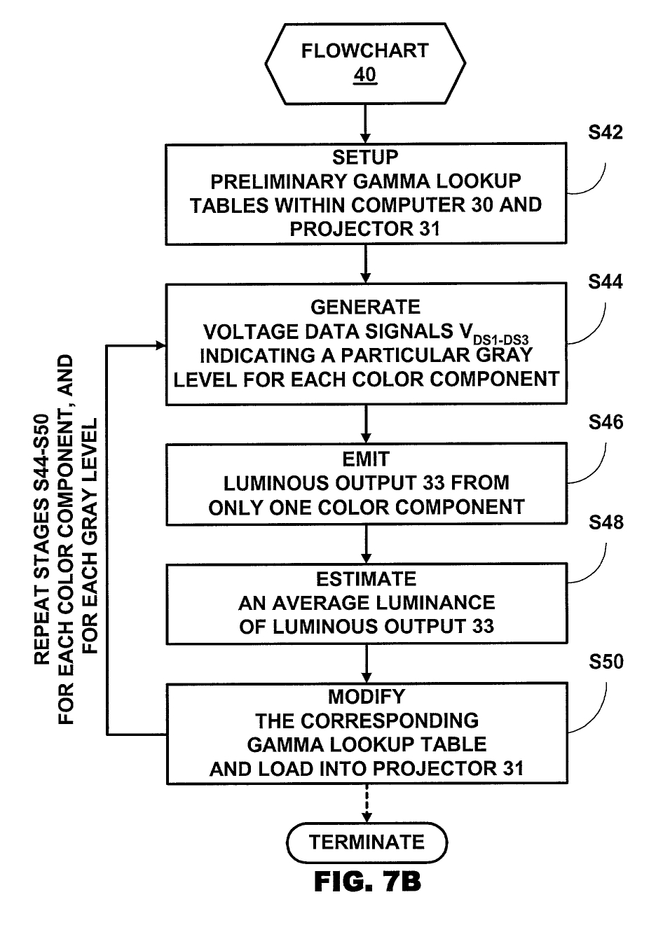

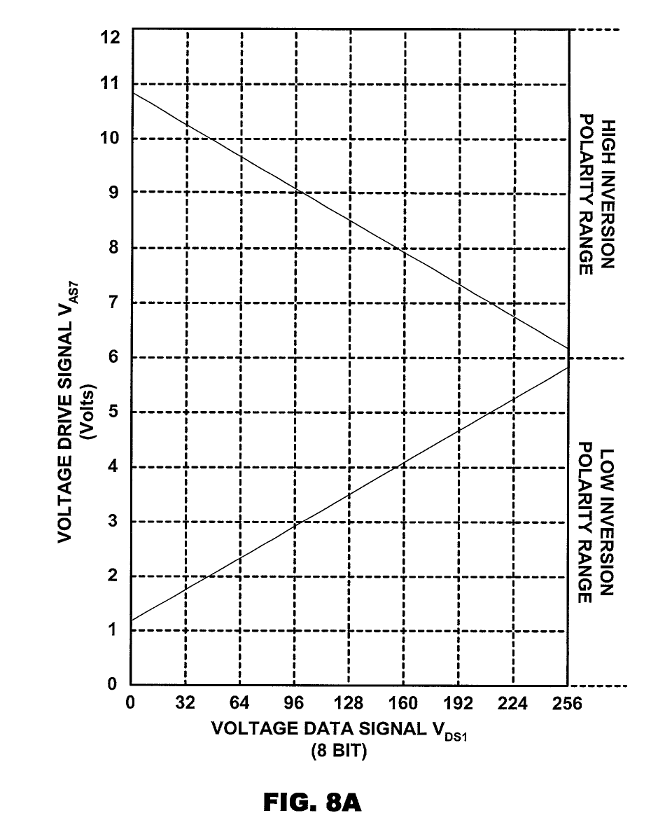

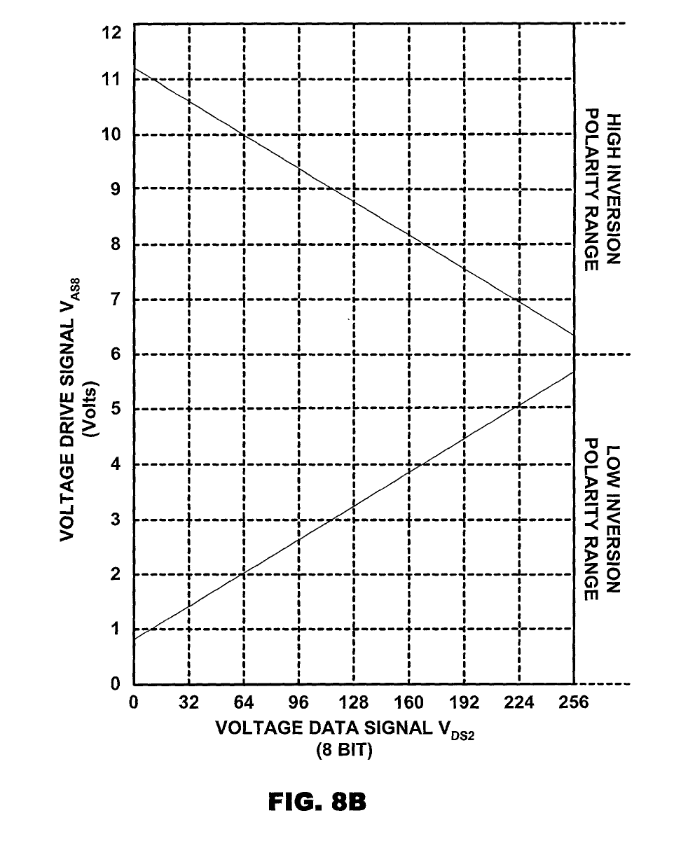

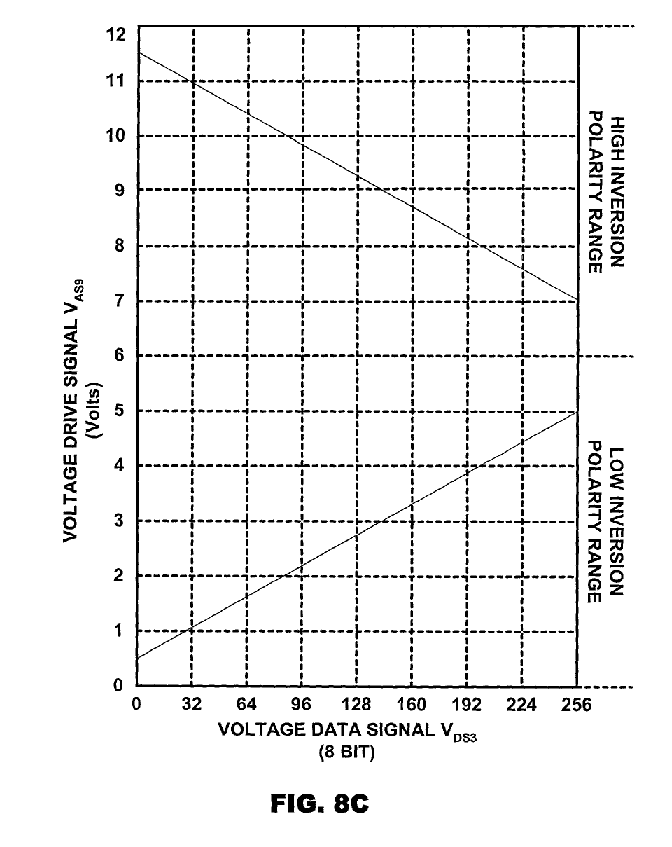

A system of the present invention as illustrated in FIG. 7A implements a method of the present invention as represented by a flowchart 40 illustrated in FIG. 7B for constructing the gamma lookup tables for gamma circuit 20. During a stage S42 of flowchart 40, preliminary gamma lookup tables for each color component are setup by a computer 30 (e.g., any type of personal computer or workstation) and loaded into a conventional projector 31. FIG. 8A illustrates an exemplary preliminary red color gamma lookup table having a linear relationship between the drive voltage levels of voltage drive signal V_{AS7} and the data voltage levels of voltage data signal V_{DS1}, based upon previously established drive voltage levels of voltage drive signal V_{AS7} corresponding to a data voltage level of 0 for voltage data signal V_{DS1} and previously established drive voltage levels of voltage drive signal V_{AS7} corresponding to a data voltage level of 255 for voltage data signal V_{DS1}. The previously established drive voltage levels of 0 and 255 correspond to the black voltage and the white voltage, respectively, for the red color.

FIG. 8B illustrates an exemplary preliminary green color gamma lookup table having a linear relationship between the drive voltage levels of voltage drive signal V_{AS8} and the data voltage levels of voltage data signal V_{DS2} based upon previously established drive voltage levels of voltage drive signal V_{AS8} corresponding to a data voltage level of 0 for voltage data signal V_{DS2} and previously established drive voltage levels of voltage drive signal V_{AS8} corresponding to a data voltage level of 255 for voltage data signal V_{DS2}. The previously established drive voltage levels of 0 and 255 correspond to the black voltage and the white voltage, respectively, for the green color.

FIG. 8C illustrates an exemplary preliminary blue color gamma lookup table having a linear relationship between the drive voltage levels of voltage drive signal V_{AS9} and the data voltage levels of voltage data signal V_{DS3} based upon previously established drive voltage levels of voltage drive signal V_{AS9} corresponding to a data voltage level of 0 for voltage data signal V_{DS3} and previously established drive voltage levels of voltage drive signal V_{AS9} corresponding to a data voltage level of 255 for voltage data signal V_{DS3}. The previously established drive voltage levels of 0 and 255 correspond to the black voltage and the white voltage, respectively, for the blue color.

Referring again to FIGS. 7A and 7B, during a stage S44 of flowchart 40, a computer 30 is operated to generate voltage data signals V_{DS1-DS3} having data voltage magnitudes indicating a gray level for the red color component, the green color component, and the blue color component, respectively. For example, during an initial execution of stage S44, computer 30 can be operated to generate voltage data signals V_{DS1-DS3} having data voltage magnitudes indicating a gray level of 0 for the red color component, the green color component, and the blue color component, respectively.

During a stage S46 of flowchart 40, projector 31 is operated to emit luminous output 33 from only one of the color components in a frame inversion manner. This can be accomplished by having projector 31 blank out the other two color components. For example, during an initial execution of stage S46, projector 31 can be operated to blank out the green color component and the blue color component whereby the luminous output 33 is based solely on the red color component.

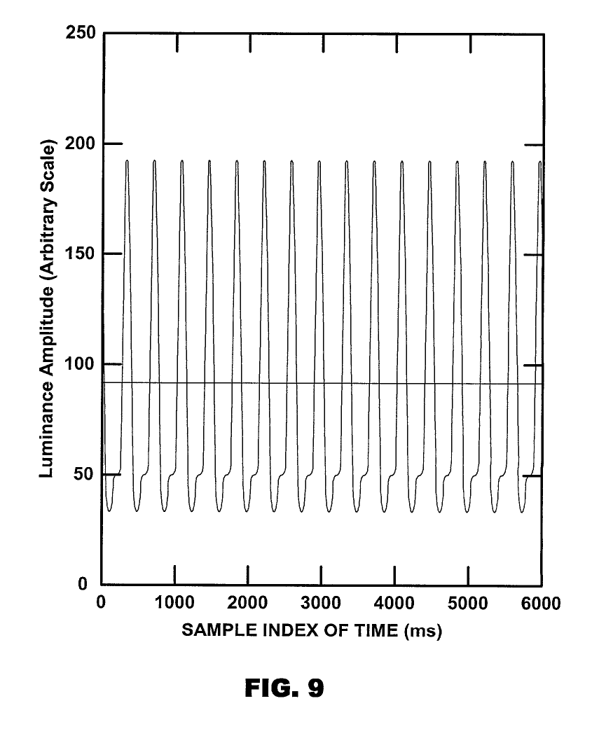

During a stage S48 of flowchart 40, a conventional luminous measurement apparatus 32 is operated to estimate an average luminance luminous output 33 per frame. In one embodiment, luminous measurement apparatus 32 includes a photodiode having a photometric filter to perform multiple measurements of luminous output 33 within one frame, and a data acquisition card to convert each measurement from analog form to digital form. Luminous measurement apparatus 32 averages the measurements over the frame to obtain a smooth and reliable estimate of the average luminance measured within the frame, and provides a voltage measurement signal VMS having a measure voltage level indicative of the average luminance as estimated. For example, FIG. 9 illustrates a time-based amplitude measurements of luminous output 33 having an average luminance represented by the horizontal line.

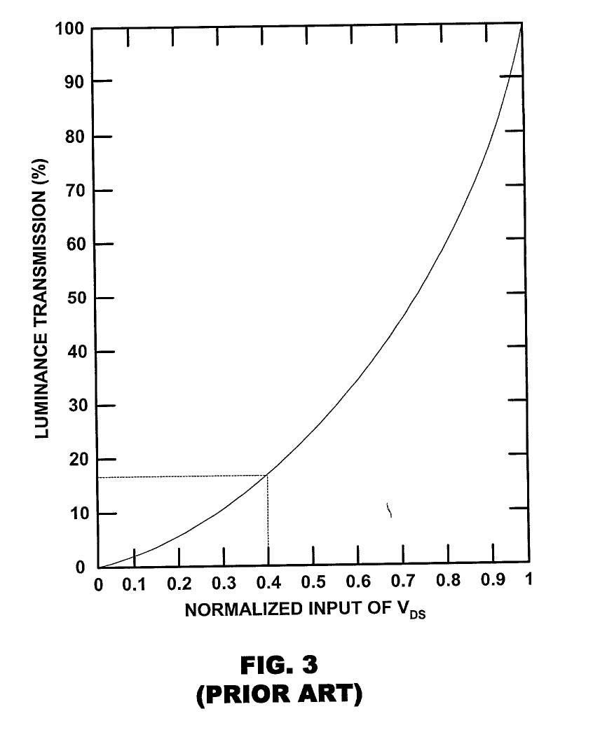

During a stage S50 of flowchart 40, computer 30 is operated to modify the appropriate gamma lookup in response to voltage measurement signal V_{MS}. The modification reflects the pair of drive voltage levels corresponding to the gray level indicated by the data voltage level. The pair of drive voltage levels have opposing polarities relative to a reference voltage level of six (6) volts with the benefit being a development of a gamma lookup table that facilitates the proper average luminance that is desired for the graylevel indicated by the data voltage signal as shown in FIG. 3 and equalizes the peaks of the luminance waveform as shown in FIG. 9.

Stages S44-S50 are then repeated as needed in any order whereby the preliminary red color gamma lookup table of FIG. 8A is transformed to the red color gamma lookup table of FIG. 6A, the preliminary green color gamma lookup table of FIG. 8B is transformed to the green color gamma lookup table of FIG. 6B, and the preliminary blue color gamma lookup table of FIG. 8C is transformed to the blue color gamma lookup table of FIG. 6C. The gamma lookup tables of FIGS. 6A-6C are then setup within gamma circuit 10 (FIG. 5) whereby the display driver can implement the inversion flicker compensation to luminous output 14 (FIG. 5) as emitted by LCD device 13 (FIG. 5).

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A device, comprising:
a liquid crystal display device operable to emit a luminous output in response to a reception of a voltage drive signal and a voltage reference signal; and
a display driver operable to provide the voltage drive signal to the liquid crystal display device in response to a reception of a voltage data signal having a data voltage level indicative of a gray level, said display driver including a gamma lookup table for the voltage drive signal,
wherein the gamma lookup table lists a pair of drive voltage levels for the voltage drive signal that correspond to the gray level as indicated by the data voltage level of the voltage data signal, and
wherein the drive voltage levels have opposing polarities relative to a reference voltage level of the voltage reference signal.

2. The device of claim 1, wherein said display driver includes:
a gamma circuit operable to retrieve the drive voltage levels from the gamma look up table in response to a reception of the voltage data signal; and
a digital-to-analog converter operable to transform the voltage data signal into the voltage drive signal in response to a retrieval by said gamma of the drive voltage levels from the gamma look up table.

3. A device, comprising:
a liquid crystal display device operable to emit a luminous output in response to a reception of a voltage drive signal and a voltage reference signal; and
a display driver operable to provide the voltage drive signal to the LCD device in response to a reception of a voltage data signal,
wherein said display driver includes means for applying an inversion flicker compensation to the luminous output.

4. A method for applying an inversion flicker compensation to a luminous output being emitted by a liquid crystal display device in response to a reception of one or more voltage drive signals and a voltage reference signal, said method comprising:
operating a display driver to receive a first voltage data signal having a first data voltage level indicative of a first gray level for a first color component;
operating the display driver to obtain a first pair of drive voltage levels for a first voltage drive signal from a gamma lookup table in response to a reception of the first voltage data signal having the first data voltage level, the first pair of drive voltage levels having opposing polarities relative to a reference voltage level of the voltage reference signal; and
operating the display driver to provide the first voltage drive signal to the liquid crystal display device in a frame inversion manner involving the first pair of drive voltage levels during a duration of the first data voltage level indicating the first gray level.

5. The method of claim 4, further comprising:
operating the display driver to receive a second voltage data signal having a second data voltage level indicative of a second gray level for a second color component;
operating the display driver to obtain a second pair of drive voltage levels for a second voltage drive signal from a gamma lookup table in response to a reception of the second voltage data signal having the second data voltage level, the second pair of drive voltage levels having opposing polarities relative to the reference voltage level of the voltage reference signal; and
operating the display driver to provide the second voltage drive signal to the liquid crystal display device in a frame inversion manner involving the second pair of drive voltage levels during a duration of the second data voltage level indicating the second gray level.

6. The method of claim 4, further comprising:
operating the display driver to receive the first voltage data signal having a second data voltage level indicative of a second gray level for the first color component;
operating the display driver to obtain a second pair of drive voltage levels for the first voltage drive signal from a gamma lookup table in response to a reception of the first voltage data signal having the second data voltage level, the second pair of drive voltage levels having opposing polarities relative to the reference voltage level of the voltage reference signal; and
operating the display driver to provide the first voltage drive signal to the liquid crystal display device in a frame inversion manner involving the second pair of drive voltage levels during a duration of the first data voltage level indicating the second gray level.

7. A method, comprising:
receiving a first voltage data signal having a first data voltage level indicative of a first gray level for a first color component;
obtaining a first pair of drive voltage levels for a first voltage drive signal in response to a reception of the first voltage data signal having the first data voltage level, the first pair of drive voltage levels having opposing polarities relative to a reference voltage level of a voltage reference signal being applied to a liquid crystal display device; and
providing the first voltage drive signal to the liquid crystal display device in a frame inversion manner involving the first pair of drive voltage levels of the first voltage drive signal during a duration of the first data voltage level indicating the first gray level.

8. The method of claim 7, further comprising:
receiving a second voltage data signal having a second data voltage level indicative of a second gray level for a second color component;
obtaining a second pair of drive voltage levels for a second voltage drive signal in response to a reception of the second voltage data signal having the second data voltage level, the second pair of drive voltage levels having opposing polarities relative to the reference voltage level of the voltage reference signal being applied to the liquid crystal display device; and
providing the second voltage drive signal to the liquid crystal display device in a frame inversion manner involving the second pair of drive voltage levels of the second voltage drive signal during a duration of the second data voltage level indicating the second gray level.

9. The method of claim 8, further comprising:
receiving the first voltage data signal having a second data voltage level indicative of a second gray level for the first color component;
obtaining a second pair of drive voltage levels for the first voltage drive signal in response to a reception of the first voltage data signal having the second data voltage level, the second pair of drive voltage levels having opposing polarities relative to the reference voltage level of the voltage reference signal being applied to the liquid crystal display device; and
providing the first voltage drive signal to the liquid crystal display device in a frame inversion manner involving the second pair of drive voltage levels of the first voltage drive signal during a duration of the first data voltage level indicating the second gray level.

10. A method, comprising the steps of:
emitting a luminous output from a liquid crystal display device in response to a reception of one or more voltage data signals; and
applying an inversion flicker compensation to the luminous output.
